(19) United States
(12) Patent Application Publication
(10) Pub. No.: US 2002/0106234 A1
(43) Pub. Date: Aug. 8, 2002

(54) Chew brush

(76) Inventor: Kenneth W. Johnson, Mesa, AZ (US)

Correspondence Address: Steven Thrasher, 391 Sandhill Dr., Richardson, TX, 75080, US

(21) Appl. No.: 10/061,676

(22) Filed: Feb. 1, 2002

Related U.S. Application Data
(60) Provisional application No. 60/266,403, filed on Feb. 2, 2001.

(51) Int. Cl. B43K 5/14

(52) U.S. Cl. 401/134; 401/132

(57) ABSTRACT

The invention provides a chewable tooth-cleaning device (chewable toothbrush). The chewable toothbrush is made of at least a flexible shell, a plurality of bristles coupled to the shell so that the bristles are substantially protruding from the exterior of the shell, a chewable centerpiece disposed within a shell interior, and a burstable capsule disposed adjacent to the chewable centerpiece within the shell interior. The invention is also a method of promoting oral hygiene by using the device.

### RELATED APPLICATION

The invention relates to and claims priority from U.S. Provisional Patent Application No. 60/266,403 entitled Chewable Toothbrush and Paste, to Johnson, Kenneth W., which was filed on Feb. 2, 2001.

### TECHNICAL FIELD

Generally, the invention relates to dental hygiene, and, more particularly, the invention relates to devices and systems for removing plaque from teeth and gums, and for freshening breath.

### STATEMENT OF A PROBLEM ADDRESSED BY THIS INVENTION

It is recognized that good dental hygiene is an important part of human health. Good hygiene leads to healthy teeth and gums. Contrarily, poor dental hygiene leads to gum disease that causes bad breath, tooth aches, and tooth loss. These problems often lead to poor nutrition since people with toothaches tend to eat less often. In addition, there is mounting evidence of a relationship between plaque build up, gum infections, gum disease, and heart disease.

Plaque removal and dental hygiene techniques typically involve a toothbrush having a handle and bristle-head. However, the toothbrush suffers from several disadvantages. For example, a toothbrush is not a conveniently portable device. Thus, if a person needs to brush when away from home, they must carry a bulky toothbrush and toothpaste. Then, if they want to keep the toothbrush, they must contend with finding a location to rinse the toothbrush and a means to store the wet device. Accordingly, few persons brush the United States' Dental Association's recommended three times a day, for three minutes at a time.

Accordingly, to overcome these and other disadvantages associated with existing methods of maintaining dental hygiene, it would be advantageous to have a device and system for cleaning teeth and gums that is reliable, portable, and is inexpensive enough to be disposable.

### SELECTED OVERVIEW OF SELECTED EMBODIMENTS

The invention provides technical advantages as a chewable tooth-cleaning device (chewable toothbrush). In one embodiment, the chewable toothbrush is made of a flexible shell, a plurality of bristles coupled to the shell so that the bristles are substantially protruding from the exterior of the shell, a chewable centerpiece disposed within a shell interior, and a burstable capsule disposed adjacent to the chewable centerpiece within the shell interior. The chewable toothbrush may optionally be digestible. The invention is also a method of promoting oral hygiene by using the device. The invention as disclosed and described provides an effective means for promoting oral hygiene via a portable device.

Of course, other features and embodiments of the invention will be apparent to those of ordinary skill in the art. After reading the specification, and the detailed description of the exemplary embodiment, these persons will recognize that similar results can be achieved in not dissimilar ways. Accordingly, the detailed description is provided as an example of the best mode of the invention, and it should be understood that the invention is not limited by the detailed description. Accordingly, the invention should be read as being limited only by the claims.

### BRIEF DESCRIPTION OF THE DRAWINGS

Various aspects of the invention, as well as an embodiment, are better understood by reference to the following EXEMPLARY EMBODIMENT OF A BEST MODE. To better understand the invention, the EXEMPLARY EMBODIMENT OF A BEST MODE should be read in conjunction with the drawings in which:

FIG. 1 illustrates a sewn-bristle embodiment of the invention;

FIG. 2 shows an exploded view of the invention having a formed-bristle embodiment; and

FIG. 3 is a cross sectional view of a formed-bristle embodiment.

### AN EXEMPLARY EMBODIMENT OF A BEST MODE

The invention provides a chewable tooth-cleaning device (chewable toothbrush). The chewable toothbrush is made of at least a flexible shell, a plurality of bristles coupled to the shell so that the bristles are substantially protruding from the exterior of the shell, a chewable centerpiece disposed within a shell interior, and a burstable capsule disposed adjacent to the chewable centerpiece within the shell interior. The invention is also a method of promoting oral hygiene by using the device.

Interpretation Considerations

When reading this section (An Exemplary Embodiment of a Best Mode, which describes an exemplary embodiment of the best mode of the invention, hereinafter “exemplary embodiment”), one should keep in mind several points. First, the following exemplary embodiment is what the inventor believes to be the best mode for practicing the invention at the time this patent was filed. Thus, since one of ordinary skill in the art may recognize from the following exemplary embodiment that substantially equivalent structures or substantially equivalent acts may be used to achieve the same results in exactly the same way, or to achieve the same results in a not dissimilar way, the following exemplary embodiment should not be interpreted as limiting the invention to one embodiment.

Likewise, individual aspects (sometimes called species) of the invention are provided as examples, and, accordingly, one of ordinary skill in the art may recognize from a following exemplary structure (or a following exemplary act) that a substantially equivalent structure or substantially equivalent act may be used to either achieve the same results in substantially the same way, or to achieve the same results in a not dissimilar way.

Accordingly, the discussion of a species (or a specific item) invokes the genus (the class of items) to which that species belongs as well as related species in that genus. Likewise, the recitation of a genus invokes the species known in the art. Furthermore, it is recognized that as technology develops, a number of additional alternatives to achieve an aspect of the invention may arise. Such advances are hereby incorporated within their respective genus, and should be recognized as being functionally equivalent or structurally equivalent to the aspect shown or described.

Second, the only essential aspects of the invention are identified by the claims. Thus, aspects of the invention, including elements, acts, functions, and relationships (shown or described) should not be interpreted as being essential unless they are explicitly described and identified as being essential. Third, a function or an act should be interpreted as incorporating all modes of doing that function or act, unless otherwise explicitly stated (for example, one recognizes that “tacking” may be done by nailing, stapling, gluing, hot gunning, riveting, etc., and so a use of the word tacking invokes stapling, gluing, etc., and all other modes of that word and similar words, such as “attaching”). Fourth, unless explicitly stated otherwise, conjunctive words (such as “or”, “and”, “including”, or “comprising” for example) should be interpreted in the inclusive, not the exclusive, sense. Fifth, the words “means” and “step” are provided to facilitate the reader's understanding of the invention and do not mean “means” or “step” as defined in §112, paragraph 6 of 35 U.S.C., unless used as “means for—functioning—” or “step for—functioning—” in the Claims section.

Description of the Figures

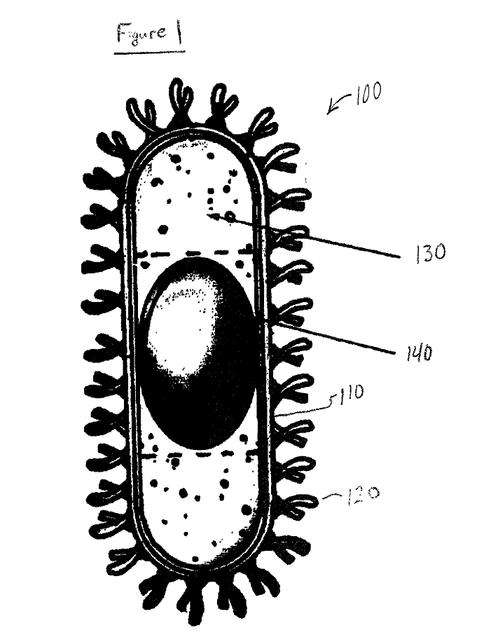

Better understanding of the invention can be obtained by reviewing the Figures. Accordingly, FIG. 1 illustrates a sewn-bristle embodiment of the invention. In general, a chewable tooth-cleaning device (chewable toothbrush) 100 includes a flexible shell (the shell) 110 that has two primary surfaces—an interior and an exterior. The chewable toothbrush 100 also has a plurality of bristles 120 coupled to the shell so that the bristles 120 are substantially protruding from the exterior of the shell 110. Notice that in FIG. 1, the bristles 120 are sewn into the shell 110. In addition, the chewable toothbrush 100 has a chewable centerpiece 130 disposed within the shell's interior. Furthermore, a burstable capsule 140 is disposed adjacent to the chewable centerpiece 130 within the shell's interior. In one embodiment, the shell 110 is shaped similarly to a tooth-brush head, and in another embodiment, the shell 110 is shaped like a toothbrush.

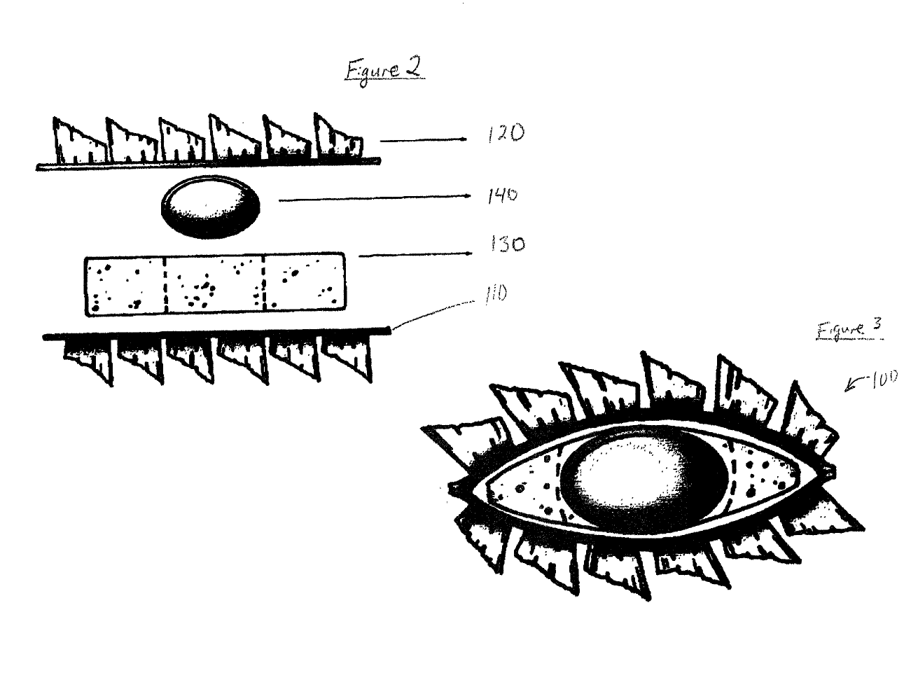

FIG. 2 shows an exploded view of the invention having a formed-bristle embodiment. The embodiment provided in FIG. 2 illustrates the bristles 120 having been integrally formed with the shell 110. In addition, the bristles 120 are, in one embodiment, substantially fan-shaped. From FIG. 2, it can also be seen that the chewable centerpiece 130 may have a substantially rectangular shape.

In addition, though not shown in FIG. 2, the chewable centerpiece 130 comprises a hole or indentation shaped substantially similar to the burstable capsule 140. Accordingly, FIG. 3 is a cross sectional view of a formed-bristle embodiment of the chewable toothbrush 100. Furthermore, although not illustrated herein, the shell 110 and bristles 120 may be formed by using a weaving process, where the shell 110 is a weave of string-like pieces, and the bristles 120 may either be woven into the shell 110, or be integrally formed by “fraying” the pieces at selected or random locations.

The flexible shell 110 is preferably a soft chewable material and may be made of polypropylene, or plastic, for example. Similarly, the bristles may be made of plastic, or the same material as the shell 110, or even a digestible substance. Likewise, the chewable centerpiece may be made of polyfoam, such as a polymeric foam with a skin-free surface, gum, or a digestible material, for example.

The burstable capsule is also highly versatile. Preferably, the burstable capsule maintains a digestible fluid, such as a paste or liquid dental cleaner. In one embodiment, the burstable capsule contains fluoride. Marketers may wish to use a food coloring in the burstable capsule, and this is perfectly within the scope of the invention. Likewise, in one embodiment, flavoring, such as mint, is maintained in the burstable capsule. It should be recognized that technology exist that enables one to produce edible and digestible components for the chewable toothbrush, accordingly, in one embodiment, chewable toothbrush is completely edible and/or digestible.

One use of the device is as a method of promoting oral hygiene. Thus, to clean one's mouth, a user may place a chewable toothbrush in their mouth, burst a burstable center of the chewable toothbrush, and chew the chewable toothbrush. In one embodiment, the user may swallow the chewable toothbrush—either in whole or in part.

Though the invention has been described with respect to a specific preferred embodiment, many variations and modifications will become apparent to those skilled in the art upon reading the present application. It is therefore the intention that the appended claims be interpreted as broadly as possible in view of the prior art to include all such variations and modifications.

I claim:

1. A chewable tooth-cleaning device (chewable toothbrush), comprising:
a flexible shell, the shell having an interior and an exterior;
a plurality of bristles coupled to the shell so that the bristles are substantially protruding from the exterior of the shell;
a chewable centerpiece disposed within the shell interior; and
a burstable capsule disposed adjacent to the chewable centerpiece within the shell interior.

2. The chewable toothbrush of claim 1 wherein the bristles are sewn into the shell.

3. The chewable toothbrush of claim 1 wherein the flexible shell is formed from a soft chewable material.

4. The chewable toothbrush of claim 1 wherein the bristles are made of plastic.

5. The chewable toothbrush of claim 1 wherein the bristles are made of the same material as the shell.

6. The chewable toothbrush of claim 1 wherein the chewable centerpiece is made of polyfoam.

7. The chewable toothbrush of claim 1 wherein the chewable centerpiece is made of gum.

8. The chewable toothbrush of claim 1 wherein the plurality of bristles are coupled to the shell via weaving.

9. The chewable toothbrush of claim 1 wherein the plurality of bristles are integrally formed with the shell.

10. The chewable toothbrush of claim 1 wherein the burstable capsule maintains a digestible fluid.

11. The chewable toothbrush of claim 1 wherein the burstable capsule maintains a digestible paste.

12. The chewable toothbrush of claim 1 wherein the burstable capsule contains fluoride.

13. The chewable toothbrush of claim 1 wherein the shell comprises polypropylene.

14. The chewable toothbrush of claim 6 wherein the chewable centerpiece is made of polyfoam, the polyfoam being a polymeric foam with a skin-free surface.

15. The chewable toothbrush of claim 1 wherein the chewable centerpiece comprises a hole shaped substantially similar to the burstable capsule.

16. The chewable toothbrush of claim 1 wherein the burstable capsule maintains a food coloring.

17. The chewable toothbrush of claim 16 wherein the burstable capsule maintains a flavoring.

18. The chewable toothbrush of claim 1 wherein the chewable toothbrush is digestable.

19. A method of promoting oral hygiene, comprising:
placing a chewable toothbrush in the mouth;
bursting a burstable center of the chewable toothbrush; and
chewing the chewable toothbrush.

20. The method of claim 19 further comprising swallowing the chewable toothbrush.
